(19) United States
(12) Patent Application Publication
(10) Pub. No.: US 2016/0344259 A1
(43) Pub. Date: Nov. 24, 2016

(54) SYSTEM FOR STORING AND GENERATING ELECTRIC ENERGY FOR AN AQUATIC MEDIUM

(71) Applicant: Christophe STEVENS, Charroux (FR)

(72) Inventor: Christophe STEVENS, Charroux (FR)

(21) Appl. No.: 15/114,049

(22) PCT Filed: Jan. 26, 2015
(86) PCT No.: PCT/IB2015/000066

§ 371 Date: Jul. 25, 2016

(30) Foreign Application Priority Data
Jan. 28, 2014 (FR) 14/00195

(51) Int. Cl. H02K 7/18; B63B 35/44; H02K 7/10

(52) U.S. Cl. CPC H02K 7/1853; H02K 7/1004; B63B 35/44; B63B 2035/4433

(57) ABSTRACT

System for storing and generating electric energy for an aquatic medium, including a plurality of weights, each provided with a tank capable of accommodating a given amount of air and/or water and a gripping means in a substantially hermetic manner, a lift-generator, arranged to engage with the weights and provided to allow said weights, in the generator mode, to descend to the bottom area, and, in the motor mode, to rise back up toward the surface, a main float, capable of supporting the upper portion of the lift-generator at the surface, a reversible motor, engaging with the lift-generator and making it possible, in the generator mode, to produce electric energy due to the action of the weights during the descent thereof, and, in the motor mode, to actuate the lift-generator in order to raise the weights.

### TECHNICAL FIELD OF THE INVENTION

The present invention relates to a system for storing and generating electric energy for an aquatic medium.

### DESCRIPTION OF THE PRIOR ART

Many working groups are actively investigating the issues of energy storage. Although many solutions have already been identified or even implemented, none of the current solutions leads to a genuine breakthrough allowing the growing energy needs to be satisfied.

The challenges of modern times are related to transportation, where it is required to store large amounts of electric energy as a substitute for fossil energy which is both polluting and limited in time. They are also related to domestic and industrial electricity consumption, largely from energy-producing power plants. In this case, one of the most important issues to be resolved relates to the peak periods, when consumption reaches very high levels, although for relatively limited periods of time. However, as it is today not possible to store energy amounts that are equivalent to the difference between the average and peak consumptions, plants must be sized for the highest consumption levels. This represents very high levels of investment. Many backup plants also exist, which are designed to operate during peak periods. These plants are often gas or coal-fired, and represent significant sources of pollution. If the surplus energy required for peak periods could be stored during off-peak periods, this would avoid building these backup plants.

Patent application DE10333513 relates to a non-continuously operating drive which is suitable for all water depths and can be charged once with the required energy amount. A working machine to be used under water, in particular, in deep sea, is provided with a power transmission device. A floating body, placed at the free end of a rope, and provided with a closed incompressible sphere, can be charged by buoyancy energy. As the drive is lowered, potential energy is absorbed by means of the stopped floating body and, after the drive has been placed in position, said energy can be converted into mechanical work through a controlled release of the ratchet mechanism.

Document US2010109329 describes a sliding mechanism for producing electric energy from the interaction of a conductor with a number of magnetic elements on a carrier assembly. The carrier assembly moves on the shaft, and, when falling, it moves in a second direction due to the gravitational force. It furthermore has a slowing mechanism arranged to slow down the movement of the buoyant assembly in order to separate an outer surface of the buoyant assembly from the fluid along at least one portion of the first or second direction.

Document JPS569671 describes a system for storing and generating electric energy for an aquatic medium, which comprises a float, by applying the action of an energy source for sinking a float under water in order to preserve and store energy.

The above three documents describe systems which use floats for accumulating potential energy when the floats are on the seafloor. These solutions are costly and complex to implement, in particular if it desired to use several floats that have to be attached/detached sequentially.

Document WO2010051630 describes an energy generation and storage system that uses a buoyant balloon suspended in a fluid and connected by a tether to a reel. The tether is taut and keeps the balloon from rising due to the buoyant force. A motor can wind the reel in such a way that the balloon is pulled down against the buoyant force. Energy can be extracted from the system by allowing the balloon to rise, pulling on the tether and rotating the reel that is connected to a generator.

This system, which is in part aquatic and in part ground-based, requires a suitable terrain and only works using a single float.

Document DE102006059233 describes an energy storage device for temporarily generating electric energy. The method works by immerging an energy storage means into a liquid, where the body has a smaller specific weight than that of the liquid.

Patent application DE4135440 describes a ground-based energy generating plant for providing energy in a power distribution network in order to cover daily peak energy consumption periods.

These documents describe solutions that are cumbersome and complex to implement, with relatively limited effective heights.

Therefore, there is a need for more efficient, economical and environmentally-friendly solutions.

To overcome these drawbacks, the invention provides various technical means.

### DISCLOSURE OF THE INVENTION

A first object of the invention is to provide a system for storing and generating electric energy for coping with electric energy consumption peaks alternating with a low consumption.

Another object of the invention is to provide a system for storing and generating a large amount of electric energy.

Still another object of the invention is to provide an autonomous system for storing and generating electric energy which operates on demand in accordance with consumption peaks.

Another object of the invention is to provide a solution which uses the available space, in the most environmentally-friendly way possible, and which is weather proof.

For that purpose, the invention provides a system for storing and generating electric energy for an aquatic medium, including:

a plurality of weights, each cooperating with at least one tank capable of accommodating a given amount of air and/or water in a substantially hermetic manner, and a gripping means;

a lift-generator, arranged such as to engage with the weights and provided so as to allow said weights, in the generator mode, to descend to the bottom area, and, in the motor mode, to rise back up toward the surface;

a main float, capable of supporting the upper portion of the lift-generator at the surface;

a reversible motor, engaging with the lift-generator and making it possible, in the generator mode, to produce electric energy due to the action of the weights during the descent thereof, and, in the motor mode, to actuate the lift-generator in order to raise the weights.

According to such an architecture, the invention provides an on demand solution which allows the electric consumption peaks as well as the off-peak periods to be managed. The tanks can be internal or external to the weights.

According to an advantageous embodiment, the system has a reversible motor, carried by the main float, which engages with the upper portion of the lift-generator.

According to another advantageous embodiment, the lift-generator consists of a set of pulleys which drive a belt between the main float and the bottom.

According to another advantageous embodiment, the set of pulleys includes a surface pulley carried by the main float and a bottom pulley.

According to another advantageous embodiment, the surface pulley engages mechanically with the reversible motor by means of a transmission.

According to another advantageous embodiment, the lift-generator consists of a winch carried by the main float, a winch cable and at least one hook.

Advantageously, the winch engages mechanically with the reversible motor by means of a transmission.

Also advantageously, the weights have a substantially elongated shape, with the tank being arranged mainly toward one of the ends, and with a float engaging with said one end.

Also advantageously, each of the weights includes a controller for managing the fluidic flows of the amount of air and water in the tank in fluidic engagement with the inside of the tank and the outside of the weight.

The invention also provides a method for storing and generating electric energy for an aquatic medium, including the steps of:

in the generator mode, ensuring the descent of a plurality of weights to the bottom area by means of a lift-generator, which connects a main float substantially at the surface to a bottom area, such that the force exerted by the weights allows the lift-generator to actuate a reversible motor in the electric energy production mode; and

in the motor mode, raising said weights back up toward the surface, by means of the lift-generator, the reversible motor then being in the motor mode and providing the motor capability of the lift-generator.

### DESCRIPTION OF THE DRAWINGS

All implementation details are given in the following description, with reference to FIGS. 1 to 5, which are provided by way of non-limiting example, and in which:

FIG. 1 is a schematic representation of a first implementation example of a system for storing and generating energy in an aquatic medium according to the invention, implemented by a pulley system;

FIG. 2 is a schematic representation of a second implementation example of a system for storing and generating energy in an aquatic medium according to the invention, implemented by a winch;

FIG. 3 is a sectional elevation of an example of weights for use in a system for storing and generating energy in an aquatic medium according to the invention;

FIG. 4 illustrates another embodiment of the system for storing and generating energy of FIG. 1;

FIG. 5 illustrates the weights-tank assembly of the system for storing and generating energy of FIG. 4.

### DETAILED DESCRIPTION OF THE INVENTION

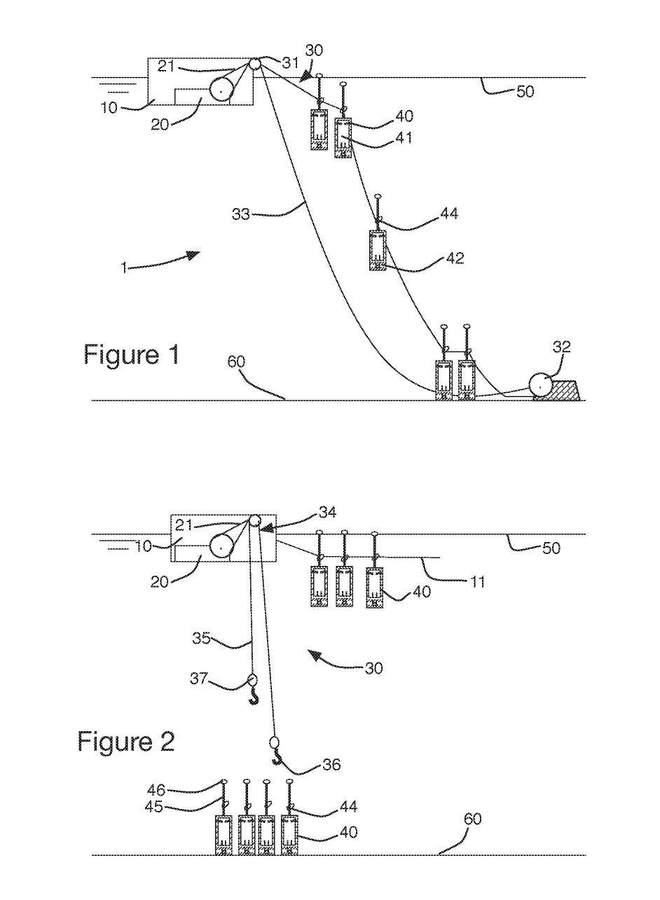

FIG. 1 illustrates a first embodiment of a system for storing electric energy for use in a marine environment according to the invention, wherein potential energy is stored by means of a plurality of weights 40, which, during the descent thereof toward the bottom 60 of the water, actuate a generator in order to produce electric energy. This energy is advantageously produced during peak consumption periods of a main network connected to the system of the invention, in order to relieve the main energy producing network.

The system advantageously includes a large number of weights 40, thus making it possible to generate energy repeatedly (or continuously), in a sustainable manner.

The illustrated system includes a main float 10, adapted to accommodate one or more reversible motors 20 substantially at the surface of the aquatic medium in question. The main float 10 also serves as a support to maintain the upper portion of a lift-generator 30 described below substantially at the surface or under the surface of the water.

The lift-generator 30 consists of a device for moving one or more weights 40 toward the bottom or toward the surface of the water. A transmission 21 allows the lift-generator 30 to be connected to the reversible motor 20. Each of the weights 40 has a tank 41 intended for accommodating an amount of air and/or water, which is suitable for compensating or increasing the the load of weight 40 at least partially, in order either to ensure storage at a position which is substantially at the surface of the water, or conversely, to promote downward descent.

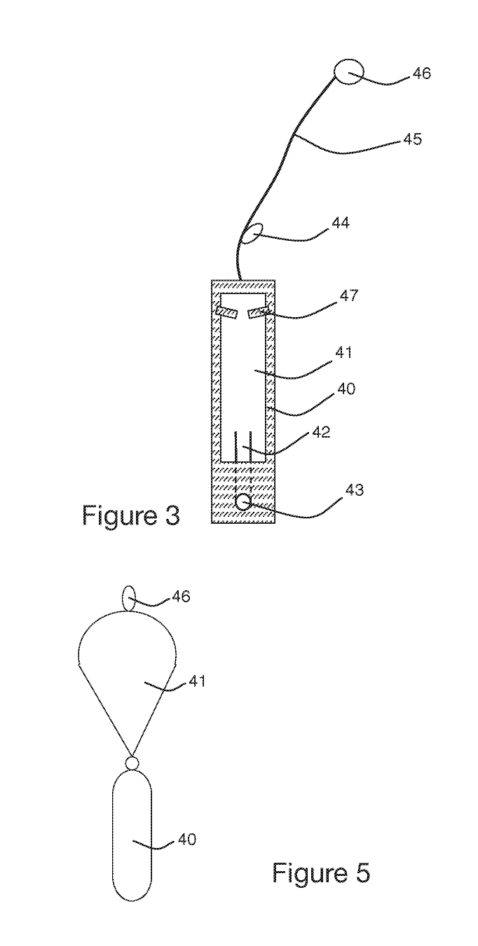

According to this first embodiment, the tank 41 is arranged inside weight 40. The detailed arrangement is described more in detail with reference to FIG. 3.

In the first embodiment illustrated in FIG. 1, the lift-generator 30 comprises a set of pulleys ensuring the rotational movement of a belt 33 or a cable engaging with the pulleys. In this example, a surface pulley 31 carries the upper portion of the lift-generator 30 and a bottom pulley 32 ensures that the belt is maintained toward the bottom 60 or on the seafloor. Transmission 21 provides a mechanical connection between the surface pulley 31 and the reversible motor 20.

In the electric energy production mode, the weights 40 descend one by one toward the bottom 60, being guided by the lift-generator 30, which then operates in the generator mode. The energy produced by the reversible motor 20 is sent over a cable to a consumption site, which is located, for example, on a nearby shore (not shown in the Figures). When all of the weights 40 are at the bottom 60, the system stops generating energy. When a period of low consumption of electricity occurs, the lift-generator 30 can be used in the motor mode, to rise the weights 40 back toward the surface 50, at a storage position. The required energy comes from a production site, which is electrically connected to the system. Once the weights 40 have been raised back up they can remain at a storage position as long as required, until a next peak-consumption period in the main connected network, in order to relieve this network's plants to cope with the peak-consumption periods.

FIG. 2 illustrates an alternative implementation of the system of FIG. 1, wherein the lift-generator 30 comprises a winch 34 provided on the main float 10, and connected to the motor-generator 20 through the transmission 21. The winch 34 serves to actuate a winch cable 35 provided with hooks (two hooks 36 in this example).

A hook float 37 can be positioned near hook 36 to aid in its proper positioning opposite the gripping means 44 for weights 40, and thus facilitate the operations of hooking and unhooking the weights 40. Weight floats 46, which are preferably isochoric, are connected to the weights 40 by the weight cables 45, which also serve to link the weights 40 to the gripping means 44 (in the form of loops in this example).

FIG. 3 shows a sectional view of an example of weights 40 according to this first embodiment. The weight 40 advantageously has an elongated cylinder or rectangle shape, provided with an internal tank 41 in its upper portion. A fluidic flow controller 42 manages fluid inputs and/or outputs to/from tank 41 for controlling the movements of weights 40. Controller 42 admits a certain amount of water to initiate the descent of weights 40 toward the bottom. In the raising phase, controller 42 releases the water, thus promoting the flotation of weight 40 and its storage in the surface area. Controller 42 is controlled either automatically by the storage and generator system and/or remotely, by a manual or automatic operator, which is located remotely. Alternatively, the descent may also be initiated by moving the weights 40 toward the bottom.

An input/output channel 43 of tank 41 enables fluidic exchanges between tank 41 and the outside. In the illustrated example, the weights 40 furthermore include air-retaining shutters 47, for avoiding air leaks if the tank 41 is unintentionally placed in a tilted position.

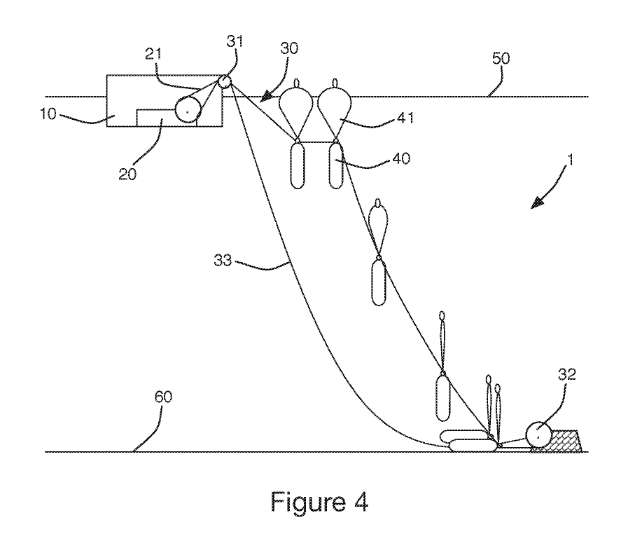

FIGS. 4 and 5 illustrate a second embodiment of the invention. According to this second embodiment, weights 40 are solid and are connected to external inflatable tanks 41. An upper float 46 (similar to that in FIGS. 1 to 3) is additionally provided in the assembly. FIG. 5 illustrates a weight 40 connected to an external tank 41. The external tank 41 comprises a flexible shell filled with air. Several types of flexible materials can be used to form the tank's shell. A polymer material is preferably used. In the inflated mode, the tank 41 is sized so that the weights 40 can float at the surface 50 of the water. In the deflated mode, the tank 41 loses its flotation effect and weight 40 descends to the bottom 60. FIG. 4 illustrates these two modes, as well as the transition phase of deflating and descent toward the bottom.

As in the previous embodiment, the descent of weights 40 toward the bottom 60 drives the lift-generator 30, which then operates in the generator mode, thus allowing energy to be generated.

The Figures and their above descriptions illustrate the invention rather than limit it. In particular, the invention and its different alternatives have been described above with reference to a particular example which includes weights with a simple tank.

The upper float can be made of a set of floats to facilitate transport and assembly, provide some dimensioning flexibility (industrialization) and adapt more flexibly to the shape of the sea surface under stormy weather.

There is at least one belt 33 or chain with two pulleys to provide a constant tension between the two pulleys, but there may also be several chains or belts and several pulleys.

The motor may run as a generator and, conversely, according to the operating mode. Two separate elements may also be provided.

The power of the energy regulating device can be modulated by varying the velocity of the chain/belt or by varying the number and mass of the hooked weights 40.

The reference numerals in the claims have no limiting character. The words “comprise” and “include” do not exclude the presence of items other than those listed in the claims.

### REFERENCE NUMERALS USED IN THE FIGURES

10 Main float
20 Reversible motor
21 Transmission
30 Lift-generator
31 Surface pulley
32 Bottom pulley
33 Belt
34 Winch
35 Winch cable
36 Hooks
37 Hook float
40 Weights
41 Tank
42 Fluidic flow controller
43 Input/output channel
44 Gripping means
45 Weight cable
46 Float
47 Air-retaining shutters
50 Water surface
60 Water bottom area

1. A system for storing and generating electric energy for an aquatic medium, including:
a plurality of weights, each engaging with at least one tank capable of accommodating a given amount of air and/or water in a substantially hermetic manner, and a gripping means;
a lift-generator, arranged to engage with the weights and provided to allow said weights, in the generator mode, to descend to the bottom area, and, in the motor mode, to rise back up toward the surface;
a main float, capable of supporting the upper portion of the lift-generator at the surface; and
a reversible motor, engaging with the lift-generator, in the generator mode, to produce electric energy due to the action of the weights during the descent thereof, and, in the motor mode, to actuate the lift-generator in order to raise the weights.

2. The system for storing and generating electric energy for an aquatic medium according to claim 1, wherein the reversible motor is carried by the main float and engages with the upper portion of the lift-generator.

3. The system for storing and generating electric energy for an aquatic medium according to claim 1, wherein the lift-generator comprises a set of pulleys, which drive a belt between the main float and the bottom.

4. The system for storing and generating electric energy for an aquatic medium according to claim 3, wherein the set of pulleys includes a surface pulley carried by the main float and a bottom pulley.

5. The system for storing and generating electric energy for an aquatic medium according to claim 4, wherein the surface pulley engages mechanically with the reversible motor through a transmission.

6. The system for storing and generating electric energy for an aquatic medium according to claim 1, wherein the lift-generator comprises a winch carried by the main float, a winch cable, and at least one hook.

7. The system for storing and generating electric energy for an aquatic medium according to claim 6, wherein the winch engages mechanically with the reversible motor through a transmission.

8. The system for storing and generating electric energy for an aquatic medium according to claim 1, wherein the weights have a substantially elongated shape, with the tank being arranged mainly toward one end, and with a float engaging with said one end.

9. The system for storing and generating electric energy for an aquatic medium according to claim 1, wherein each of the weights includes a controller for managing the fluidic flows of the amount of air and water in the tank in a fluidic engagement with the inside of the tank and the outside of the weight.

10. A method for storing and generating electric energy for an aquatic medium, including the steps of:
in the generator mode, ensuring the descent to the bottom area of a plurality of weights by means of a lift-generator, which connects a main float substantially at the surface to a bottom area, such that the force exerted by the weights allows the lift-generator to actuate a reversible motor in the electric energy production mode; and
in the motor mode, raising said weights back up toward the surface, by means of the lift-generator, the reversible motor then being in the motor mode and providing the motor capability of the lift-generator.
